(19) United States
(12) Patent Application Publication
(10) Pub. No.: US 2024/0030866 A1
(43) Pub. Date: Jan. 25, 2024

(54) SYSTEM FOR MONITORING UNDER-PERFORMANCE OF SOLAR POWER PLANT

(71) Applicant: Prescinto Technologies Private Limited, Ahmedabad (IN)

(72) Inventors: Sanjay Bhasin, Gurugram (IN); Puneet Singh Jaggi, Ahmedabad (IN); Ram Menon, Ahmedabad (IN)

(73) Assignee: Prescinto Technologies Private Limited, Ahmedabad (IN)

(21) Appl. No.: 18/043,031

(22) PCT Filed: Aug. 24, 2021
(86) PCT No.: PCT/IB2021/057755

§ 371 Date: Feb. 27, 2023

(30) Foreign Application Priority Data
Aug. 26, 2020 (IN) 202021036817

(51) Int. Cl. H02S 50/00; H02S 40/32

(52) U.S. Cl. CPC H02S 50/00; H02S 40/32

(57) ABSTRACT

There is disclosed a system for monitoring performance of a performance monitoring system for a solar power plant. The system quantifies at least one loss in solar energy generation using data generated from a plurality of inverters in the solar power plant. The system comprises a data collection module for collecting data from the plurality of inverters and at least one weather station, over a time duration; a data processing module for analysing the collected data and segregating the losses, wherein the data processing module, when in operation, implements at least one model to segregate and quantify the losses; and a ticketing module for generating a maintenance ticket for a low-performing inverter from the plurality of inverters. Specifically, the data processing module compares at least one attribute of at least two inverters from the plurality of inverters for determining actual power losses.

### FIELD OF INVENTION

In general, the present disclosure relates to a system that identifies a faulty or underperforming inverter in a solar power plant and monitors inverters of the solar power plants for identifying the power losses. Particularly, the present disclosure relates to a performance monitoring system for a solar power plant that quantifies losses in solar energy generation using data generated from inverters. Additionally, the present disclosure relates to a method of monitoring performance of a solar power plant by quantifying losses in solar energy generation using data generated from inverters in the solar power plant.

### BACKGROUND

As the population of the world is increasing, the energy consumption is also increasing throughout the world. The sources of energy used conventionally are hydrocarbons and coal. However, these conventional sources of energy cause pollution, thus, the world is putting efforts to harnessing energy from the non-conventional energy sources. The solar power is most attractive non-conventional source of energy as the earth receives inexhaustible sunlight in abundant amount. Commercial solar power plants are being established worldwide to make a significant shift toward solar energy. A Solar power plant comprises an array of solar cells or photovoltaic cells which are devices that convert light into electric current using photovoltaic effect. The array of solar cells produces direct current (DC) power which is converted to Alternating current (AC) using inverters. The solar power plants generally have multiple number of solar panels spread across a big geographical area. Such a large-scale operation of a solar power plant poses problems in fault management and maintenance of the power plant. It is very difficult to identify faults (faults in this document implies faults as reported by inverters as well as other sources of underperformance even though there is no fault reported by any equipment, e.g. soiling losses for instance are one of the key source of underperformance but it does not originate from any fault in any equipment or a systemic loss originating from a fault solar panel but it is not reported as a fault by any equipment and is merely results in small underperformance in that inverter to which this solar panel is ultimately connected) in such a large-scale operation. The faults lead to loss in power generation. Further, there are other losses related with the solar power plants e.g. radiation losses, downtime losses, soiling losses, systemic losses. The power generation of the solar power plant is also sensitive to weather conditions and it is important to segregate lower generation due to weather conditions (which is normal behaviour) from lower generation due to dust/dirt/snow accumulation on solar panels (e.g. soiling loss) or due to fault solar panels that is not reported as a fault or an alarm but is simply observed as a minor underperformance at the inverter that the solar panel is ultimately connected to.

In the present art, PV (Photovoltaic) efficiency analysis is a common practice to calculate the losses in power generation. In PV efficiency analysis, the expected power generation which is estimated using large number of variables and assumptions such as irradiance, temperature etc. arrived at using historical averages and best guesses, from the solar power plant is compared with the actual power generated from the solar power plant. The comparison between the actual generated power and expected power results in determination and quantification of the power losses. However, these methods for quantification of losses do not help in mitigating the losses as different steps are required to reduce the different types of losses. Moreover, different types of losses are originated from different sources, e.g. soiling Losses originate from accumulation of dust/dirt particles, snow, leaves on solar panels while systemic Losses originate from faults in solar panels such as damaged by-pass diodes, hot-spots, poor electrical connections among solar panels etc. Thus, it is required to understand the sources and quantum of different types of losses at inverter level so that corrective measures can be undertaken to reduce these losses.

Currently, various performance monitoring systems are present for solar power plants which employ a model to detect power losses at the inverter level. However, the model employs comparing measured value of power with the predicted value for every inverter to detect the loss. These performance monitoring systems do not provide accurate results as the measured values of power are compared with the predicted values which are not real-time values. These methods may provide some sense of quantum of losses but they do not help in diagnosing on what reason contributed how much to underlying losses. Thus, there exists a need of performance monitoring systems which provide Real-Time analysis of inverter data to quantify and segregate different types of losses.

### SUMMARY

An object of the present disclosure is to provide an automated system for monitoring performance of a solar power plant.

Another object of the present disclosure is to provide an automated system for generating system maintenance tickets for low-performing inverters in the solar power plant.

Yet another object of the present invention is to provide a method of (for) monitoring performance of a solar power plant using the abovementioned system.

In an aspect, embodiments of the present disclosure relate to a performance monitoring system for a solar power plant, wherein the system, when in operation, quantifies at least one loss in solar energy generation using data generated from a plurality of inverters in the solar power plant, the system comprising:
a data collection module for collecting data from the plurality of inverters and at least one weather station, over a time duration;
a data processing module for analysing the collected data and segregating the losses, wherein the data processing module, when in operation, implements at least one model to segregate and quantify the losses; and
a ticketing module for generating a maintenance ticket for a low-performing inverter from the plurality of inverters,
   characterized in that, the data processing module compares at least one attribute of at least two inverters from the plurality of inverters for determining actual power losses.

The system for monitoring performance of a solar power plant, as disclosed herein, is of advantage in that it provides a real-time performance monitoring system for solar power plants which employ a model, wherein the actual values of an attribute for an inverter is compared with the actual value of attribute for all other inverters. As, the values of attributes can vary depending upon various conditions e.g. weather, moisture, dust, faults in solar panels connected to those inverters etc, thus, comparing the actual values of attributes for different inverters would result into more accurate segregation and quantification of different types of losses.

Optionally, the losses include at least one of a radiation loss, a downtime loss, a soiling loss and a systemic loss.

Optionally, the data processing module, when in operation, generates a sub-model for the plurality of inverter by measuring the at least one attribute.

Optionally, the data processing module, when in operation, clusters the generated sub-model of the plurality of inverters to remove any present outlier(s).

Optionally, the data processing module, when in operation, analyses the clustered sub-model to measure deviation among the at least one attributes for quantifying the soiling losses.

Optionally, the data processing module, when in operation, identifies maxima from the clustered sub-model for the plurality of inverters to quantify systematic losses.

Optionally, the at least on attribute includes at least one of an irradiation level, ambient temperature, and module temperature.

In another aspect, embodiments of the present disclosure relate to a method of (for) monitoring performance of a solar power plant, wherein the method quantifies at least one loss in solar energy generation using data generated from a plurality of inverters in the solar power plant, the method comprising:
collecting data from the plurality of inverters and at least one weather station using a data collection module, over a time duration;
analysing the collected data and segregating the losses using a data processing module, wherein the data processing module implements at least one model to segregate and quantify the losses; and
generating a maintenance ticket for a low-performing inverter from the plurality of inverters using a ticketing module,
   characterized in that at least one attribute of at least two inverters from the plurality of inverters are compared using the data processing module for determining actual power losses.

Optionally, the losses include at least one of a radiation loss, a downtime loss, a soiling loss and a systemic loss.

Optionally, the method includes generating a sub-model for the plurality of inverter by measuring the at least one attribute using the data processing module.

Optionally, the method includes clustering the generated sub-model of the plurality of inverters to remove any present outlier(s) using the data processing arrangement.

Optionally, the method includes analysing the clustered sub-model to measure deviation among the at least one attributes for quantifying the soiling losses.

Optionally, the method includes identifying maxima from the clustered sub-model for the plurality of inverters to quantify systematic losses.

Optionally, the at least on attribute includes at least one of an irradiation level, ambient temperature, and module temperature.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

A better understanding of the present invention may be obtained through the following examples which are set forth to illustrate but are not to be construed as limiting the present invention.

### BRIEF DESCRIPTION OF DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 is a schematic illustration of a block diagram of a performance monitoring system for a solar power plant, in accordance with an embodiment of the present disclosure;

FIG. 2 is a graphical representation of system efficiency for a particular invertor on a particular day, in accordance with an embodiment of the present disclosure;

FIG. 3 is a graphical representation for removal of outliers from the system, in accordance with an embodiment of the present disclosure;

FIG. 4 is a graphical representation of a linear regression model clustering of two inverters, in accordance with an embodiment of the present disclosure;

FIG. 5 is a graphical representation of a composite distribution of systemic loss across the plurality of inverters in ascending order, in accordance with an embodiment of the present disclosure;

FIG. 6 is a graphical representation of effectiveness of a cleaning operation(s) across the plurality of inverters in a solar power plant, in accordance with an embodiment of the present disclosure; and

FIG. 7 is a flow chart of a method of (for) monitoring performance of a solar power plant, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item to which the arrow is pointing.

### DETAILED DESCRIPTION

The following detailed description illustrates embodiments of the present disclosure and ways in which they can be implemented. Although some modes of carrying out the present disclosure have been disclosed, those skilled in the art would recognise that other embodiments for carrying out or practising the present disclosure are also possible.

In a first aspect, embodiments of the present disclosure provide a performance monitoring system for a solar power plant, wherein the system, when in operation, quantifies at least one loss in solar energy generation using data generated from a plurality of inverters in the solar power plant, the system comprising:
a data collection module for collecting data from the plurality of inverters and at least one weather station, over a time duration;
a data processing module for analysing the collected data and segregating the losses, wherein the data processing module, when in operation, implements at least one model to segregate and quantify the losses; and
a ticketing module for generating a maintenance ticket for a low-performing inverter from the plurality of inverters, characterized in that, the data processing module compares at least one attribute of at least two inverters from the plurality of inverters for determining actual power losses.

In a second aspect, a method of (for) monitoring performance of a solar power plant, wherein the method quantifies at least one loss in solar energy generation using data generated from a plurality of inverters in the solar power plant, the method comprising:
collecting data from the plurality of inverters and at least one weather station using a data collection module, over a time duration;
analysing the collected data and segregating the losses using a data processing module, wherein the data processing module implements at least one model to segregate and quantify the losses; and
generating a maintenance ticket for a low-performing inverter from the plurality of inverters using a ticketing module,
   characterized in that at least one attribute of at least two inverters from the plurality of inverters are compared using the data processing module for determining actual power losses.

The present disclosure provides the aforementioned system and a method of (for) monitoring performance of a solar power plant by segregating and quantifying at least one loss in solar energy generation using data generated from a plurality of inverters in the solar power plant. The system disclosed herein is simple, robust, inexpensive, and allows real time monitoring of the solar power plant. The system efficiently ensures detecting controllable and non-controllable losses in the inverters of the solar power plant and generates a maintenance tickets for each detected loss.

Throughout the present disclosure, the term “performance” as used herein relates to the efficiency of conversion of sunlight into electricity. Optionally, the difference between the actual power generation in the solar power plant and the expected power to be generated from the solar power plant is attributed as performance e.g. lower the difference between actual power and expected power higher is the performance of the plant or vice-versa.

In general, the term “solar power” refers to conversion of energy from sunlight into electricity either directly using photovoltaics (PV), indirectly using concentrated solar power, or a combination.

The term “solar power plant” refers to an array of solar cells or Photovoltaic (PV) cells which are devices that convert light into electric current using photovoltaic effect. Optionally, solar power plant refers to an array of PV modules, where each PV module is an assembly of PV cells mounted in a framework for installation. Optionally, the solar power plant may be connected to the grid to supply the generated electricity for household use. Optionally, the solar power plant may be connected to a particular industrial unit to fulfil the electricity requirements.

The term “inverter” refers to an electronic circuit that converts direct current (DC) to alternating current (AC). Optionally, in Solar power plants, an individual inverter may be attached to each PV module, the array of PV cells produces direct current (DC) power which is converted to Alternating current (AC) using inverters. More optionally, the output from several inverters may be combined and then fed to the grid. Optionally, the inverters may include converters which converts variable direct current outputs from a photovoltaic panel to alternating current of utility frequency that can be supplied to the commercial electric grid or can be used in a local off grid electrical network. Optionally, the inverters may include heavy capacity centralised inverters. Optionally, the inverters may include lower capacity string inverters. Optionally, the inverters may include even lower capacity micro inverters. Optionally, the inverters may include string monitoring boxes or any other device which has power measurement capabilities.

The term “data collection module” as used herein relates to programmable and/or non-programmable components that, when in operation, execute one or more software applications for measuring, obtaining, storing, or sharing of data. Optionally, the data collection module can include, for example, a component included within an electronic communications network and an array of various sensors for measuring and obtaining wide variety of data. Furthermore, the data collection module may include hardware, software, firmware or a combination of these, suitable for measuring, obtaining and sharing various information. Optionally, the data collection module may include a voltage sensor, a current sensor, an ambient temperature sensor, an irradiation sensor, a humidity sensor, tilt angle sensor, solar current sensor and so forth.

The term “weather stations” refers to the weather monitoring stations which monitor parameters such as solar radiation, other weather conditions such as wind velocity, wind direction, humidity, module temperature etc. Optionally, weather stations may calculate performance ratio (PR) of the solar power plant using all the captured data. Optionally, the weather stations may comprise Solar radiation sensor, Wind speed sensor, Wind direction sensor, PV Temperature sensor, Ambient Temperature & Humidity sensor, Irradiance Sensor and so forth.

The term “time duration” refers to length of time to analyse the collected data from the plurality of inverters connected to PV modules. Optionally, the time duration may be 7 days, 14 days, one month, two months or any predefined time interval.

The term “data processing module” as used herein relates to programmable and/or non-programmable components that, when in operation, execute one or more software applications for storing, processing and/or sharing of data. Optionally, the data processing module may include hardware, software, firmware or a combination of these, suitable for storing and processing various information and services accessed by the one or more user using the one or more user equipment.

Optionally, the data processing module may include functional components, for example, a processor, a memory, a network adapter and so forth. For example, the data processing module can be implemented using a computer, a phone (for example, a smartphone), a local server, a server arrangement (such as, an arrangement of two or more servers communicably coupled with each other), a cloud server, a quantum computer and so forth. Furthermore, data processing module is communicably coupled to the display module, via a communication module. In an example, the communication module includes but is not limited to, a dedicated hardware and software module for communication, a cellular network, short range radio (for example, such as Bluetooth®), Internet, a wireless local area network, and an Infrared Local Area Network, or any combination thereof.

The term “model” relates to a machine learning algorithm. Machine learning algorithm refers to a process or set of rules to be followed in calculations or other problem-solving operations, especially by a computer which uses historical data as input to predict new output values. Optionally, machine learning algorithms relates to a program with a specific way to adjusting its own parameters, based on the feedback received on its previous performance in making predictions about a dataset. Optionally, machine learning algorithms include: a K-nearest neighbour algorithm, a regression analysis, ensemble tree based algorithms, maximum power point tracking, a hidden Markov model, a gradient boost, a decision tree, an artificial neural network, a recurrent neural network, a long short-term memory algorithm, a generative adversarial or adaptive adversarial neural networks, a convolutional neural network or a deep convolutional neural network, a reinforcement learning algorithm, random forest algorithm, an adaptive annealing algorithm, support vector machines, a recommender system, genetic algorithm, Q learning and a deep Q-learning algorithm, wherein at least one adaptive learning algorithm or another suitable computational algorithm is implemented in a closed-loop system. The term “sub-models” refers to the models generated for every inverter in the solar modules.

The term “ticketing module” refers to programmable and/or non-programmable components that, when in operation, execute one or more software applications for organizing issues. The ticketing module in solar power plants may organize issues related to faults/events analysed in the solar power plants. Whenever an event is identified, the ticketing module generates a ticket which act as a documentation of an event and sends the ticket to the concerned department for maintenance of the low-performing inverter or component.

The term “losses” as used herein relates to a temporary drop in the capacity of electric power generation or the actual drop in the electric power produced. Optionally, the losses may include thermal losses in the system and other system losses. Optionally, the losses may include light absorption losses, mismatch losses, voltage drop losses, shadow losses, clipping losses, curtailment losses, conversion losses and other parasitic losses. Optionally, the losses may include radiation losses, downtime losses, soiling losses and so forth. Optionally, the losses may include controllable losses and uncontrollable losses. Further, the term “controllable losses” as used herein relates to above-mentioned losses which can be controlled to increase the power generation and efficiency of the system which includes soiling losses, systemic losses, downtime losses etc. Furthermore, the term “uncontrollable losses” as used herein relates to above-mentioned losses which cannot be controlled to increase the power generation and efficiency of the system e.g. radiation losses or other losses occurred due to unfavourable weather conditions. The term “radiation loss” refers to the loss caused lower than expected radiation received from sun in the period under observation. The downtime loss in solar power plant occurs when the system or part thereof shuts or goes down typically due to a fault in one or more of the inverters. As a result, the entire set of solar panels running under the inverter are rendered useless. Energy generated by these solar panels goes completely waste because inverter is malfunctioning. The system may encounter downtime due to: congestion on the distribution system, shut-down of inverter as it detects an overvoltage due to lightning strike, gird electricity failure, detection of a ground fault. Soiling loss occurs due to the accumulation of dust, dirt, pollen and other obstructions on solar modules. Wind can lift dust from the ground into the air which is later dropped onto the modules. Thus, decreasing the absorbed solar irradiance which leads to a decrease in power output from the modules. The systemic loss is associated with the energy loss on the DC side—the solar panel side and would result from fault string wiring, damage in solar panels such as hot-spot, potential induced degradation, by-pass diode active, open-circuit connection, short circuit connection, physical damage to the panel such as delamination.

The term “attributes” refer to the physical variables or parameters which are measured in respect of each inverter in solar modules. The attributes can be: an irradiance, ambient temperature, voltage, current, power, energy and module temperature. Irradiance refers to the radiant flux (power) received by a surface per unit area. Ambient temperature is the air temperature of any object or environment where equipment is stored. Module temperature refers to the operating temperature of the PV module. The variation in operating temperature of the PV module may occur due to alteration of heat flow into and out of PV module which reduces the voltage of the module and thereby reducing the output power.

The term “outliers” in machine learning refers to extreme values that deviate from other observations on data, the outliers may indicate a variability in a measurement or experimental errors. In other words, an outlier is an observation that diverges from an overall pattern on a sample.

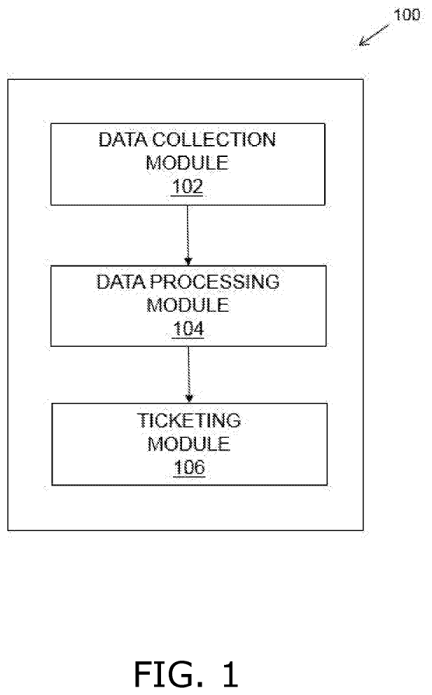

Referring to FIG. 1, there is disclosed a performance monitoring system 100 for a solar power plant. The system 100, when in operation, quantifies at least one loss in solar energy generation using data generated from a plurality of inverters in the solar power plant. The system 100 includes a data collection module 102, that when in operation, collects data from the plurality of inverters and at least one weather station, over a predefined time interval. The system 100 also includes data processing module 104, that when in operation, analyses the collected data and segregates the losses. Specifically, the data processing module 104, while segregating and quantifying the losses, implements at least one model. Further, the system 100 includes a ticketing module 106, that when in operation, generates a maintenance ticket for a low-performing inverter from the plurality of inverters.

Particularly, the data processing module 104 of the system 100, when in operation, compares at least one attribute of at least two inverters from the plurality of inverters for determining actual power losses in the solar power plant by identifying the faulty and/or underperforming inverters.

In an embodiment, the losses segregated and quantified by the data processing module 104 of the system 100 may include but not limited to a radiation loss, a downtime loss, a soiling loss and a systemic loss.

In another embodiment, the data processing module 104 of the system 100 may generate a sub-model for each of the plurality of inverter by measuring the at least one attribute.

In another embodiment, the data processing module 104 of the system 100 may cluster the generated sub-model of each of the plurality of inverters to remove at least one outlier.

In another embodiment, the data processing module 104 of the system 100 may analyse the clustered sub-model to measure deviation among the at least one attribute for quantifying the soiling losses.

In another embodiment, the data processing module 104 of the system 100 may identify maxima from the clustered sub-model for the plurality of inverters to quantify systematic losses.

In yet another embodiment, the at least on attribute may include but not limited to an irradiation level, ambient temperature, and module temperature.

The data collection module 102 of the system 100 collects data from the plurality of inverters and at least one weather station, over a predefined time interval. In general, the power generated in the solar power plant changes every day due to change in irradiation, change in the level of dust particles deposited on the solar modules, electrical or mechanical faults that may appear most recently in the system 100 and so forth. Thus, it is beneficial to analyse the data collected from the plurality of inverters over a predefined time interval, for example 30 days.

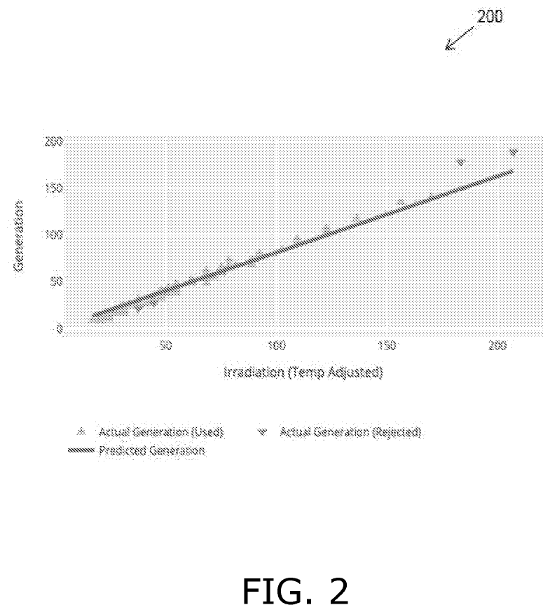

The data processing module 104 of the system 100 analyses the collected data and segregates the losses by implementing at least one model. The data processing module 102 of the system 100 generates a sub-model, “R_{id}”, for each inverter, “i”, of the plurality of inverters for each of the day, d, by measuring at least one attribute. Referring to FIG. 2, illustrated is a system efficiency graph for a particular invertor on a particular day. a linear regression sub-model, “R_{id}”, which indicates a constant trend of power generated on the particular day, “d”, for an inverter “i”. The graph further indicates the impact of temperature adjusted level of irradiation on the power generated by the inverter on the particular day. The x-axis of the graph represents a temperature adjusted level of irradiation and the y-axis of the graph represents the generated power. The solid upward arrow head represents values of actual generated power which is used. The solid downward arrow head represents values of actual generated power which are rejected as outliers. The solid trend line represents the machine learning sub-model “R_{id}” that best characterises behaviour of an inverter on a particular day. The predicted power generation increases linearly with the increase in temperature adjusted level of irradiation because of selection of the linear regression model in this embodiment. Other machine learning algorithms may also be used that may or may not result in linear or non-linear models.

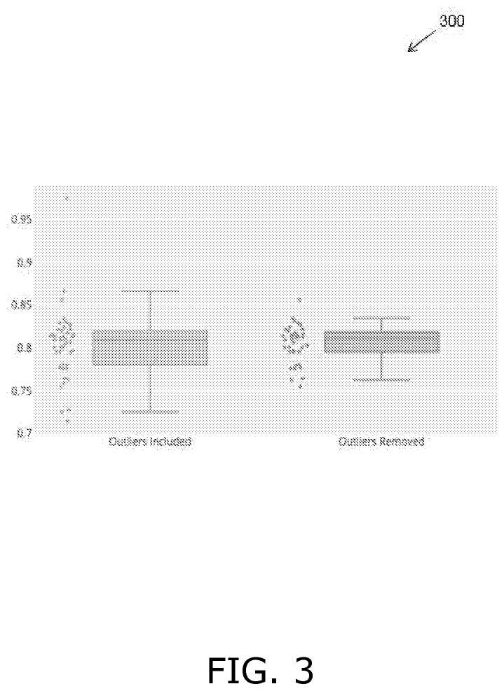

The data processing module 104 of the system 100 clusters the generated sub-model “R_{id}” of each of the plurality of inverters to remove any outlier(s) that may be present. It is possible that there may not be any outliers. Referring to FIG. 3 illustrated is the removal of outliers from the system 100. The linear regression sub-model “R_{id}” for each of the plurality of inverters for all days are clustered together to remove any outlier(s) that may be present. The outliers represent the values of generated power which deviate significantly from other values of generated power in the same inverter. The outliers are found by using multiple machine learning algorithms such as distance to the K-nearest neighbour, residuals from Ordinary Least Squares (OLS), Isolation forest, Density-Based Spatial Clustering of Applications with Noise (DBSCAN) and Local outlier factor. FIG. 3 illustrates the two different areas, which indicate the comparison of clustered sub-models “R_{id}” for an inverter with and without outliers. It is clear from the comparison of two areas that the removal of outliers provides more accurate clustered sub-models.

The data processing module 104 of the system 100 analyses the clustered sub-model for each of the plurality of inverters to measure deviation among Rᵢ for all the d values for quantifying the soiling losses. The deviation among Rᵢ values, for the particular inverter “i” and for the particular day “d”, arises due to change in level of dust deposited on the solar panel operating under said inverter “i”. Thus, the deviations among Rᵢ values, for the particular inverter “i” and for the particular day “d”, quantifies the soiling losses for the system 100.

The data processing module 104 of the system 100 analyses the clustered sub-model for each of the plurality of inverters to identify maxima, max(Rᵢ), which quantifies the systematic losses. In particular, the data processing module 104 of the system 100 compares the Rᵢ values, for the particular inverter “i”, for different days which results in a maximum “Rᵢ” among all the Rᵢ values. The max (Rᵢ) value indicates the limit of performance for the particular inverter on its cleanest day. The max (Rᵢ) values of all the plurality of inverters indicate the systematic losses for the plurality of inverters.

The present disclosure is of advantage in that it provides a real-time performance monitoring system for solar power plants which employ a model, wherein the actual values of an attribute for an inverter is compared with the actual value of the attribute for different inverters. As, the values of attributes can vary depending upon various conditions e.g. weather, moisture, dust etc, thus, comparing the actual values of attributes for different inverters would result into more accurate segregation and quantification of different types of losses.

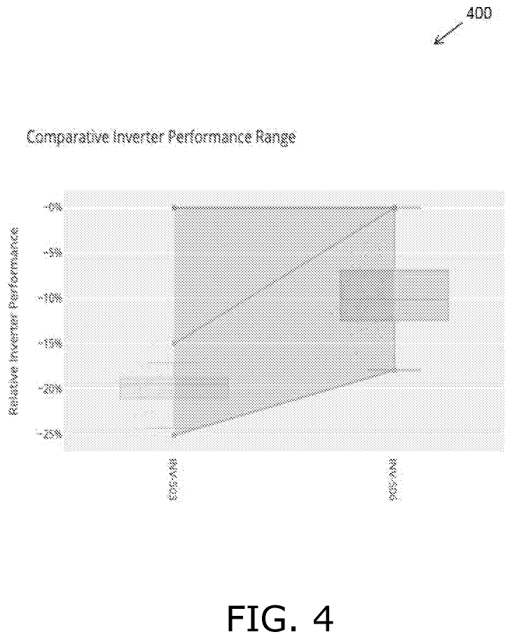

The data processing module 104 of the system 100 compares the clustered sub-models for the plurality of the inverters to identify a low-performing inverter. Referring to FIG. 4, illustrated is a linear regression model clustering of two inverters (INV-506 and INV-503). The y-axis of the graph represents relative inverter performance. The area of the graph for INV-503 indicates the clustered sub-model for INV-503 without outliers and area of the graph for INV-506 indicates the clustered sub-model for INV-506 without outliers. The graph represents the comparison of clustered sub-models of two inverters which demonstrates very low Systemic Loss for INV-506 as compared to INV-503 but with a slightly higher Soiling Loss for INV-506 when compared to INV-503. In particular, the graph indicates INV-503 as a low-performing inverter when compared to INV-506.

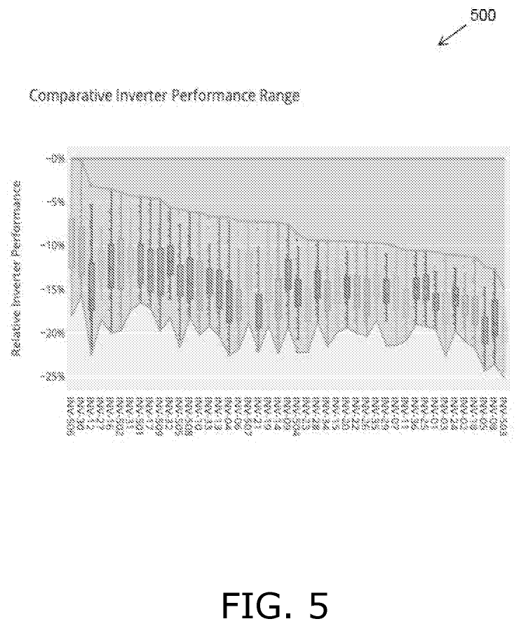

Referring to FIG. 5, illustrated is a composite distribution of systemic loss across the plurality of inverters in ascending order. The area of the graph for the plurality of inverters indicate the clustered sub-models for the corresponding inverters. The y-axis of the graph represents relative inverter performance. The graph indicates the comparison of clustered sub-models of the plurality of inverters which demonstrates that the inverter INV-506 has smallest Systemic Loss while the inverter INV-503 has the highest systematic loss.

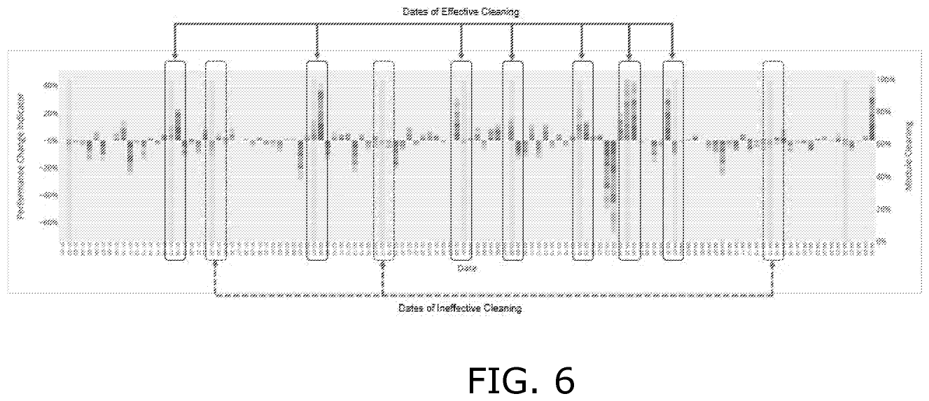

Referring to FIG. 6, illustrated is an effectiveness graph for cleaning operations of the plurality of inverters of the solar power plant. In particular, the graph illustrates results obtained from implementation of a cleaning module on various time intervals by indicating variation in the performance change indicator after the cleaning operation. The cleaning operations are considered effective when the Module Cleaning activity (indicated by the light shade bar and dates provided by the operations team) matches with incremental performance improvement observed in various inverters (indicated by the stacked bar graph—different shades indicate different inverters). Subsequently, in a situation when the Module Cleaning activity do not match with incremental performance improvement observed in various inverters, the cleaning operation is termed as ineffective. Specifically, as illustrated in the X-axis represents the dates on which the cleaning operations are performed, the Y-axis represents the performance charge indicator, the light shade bars in boxes indicates the dates on which cleaning activity is performed successfully and the light shade bars in dotted box indicates the dates on which cleaning activity is not successful or ineffective.

The ticketing module 106 of the system 100 generates a maintenance ticket for the low-performing inverters from the plurality of inverters. The generated maintenance ticket enables an operator of the solar power plant to implement the solutions to lessen the losses. For example, the operator needs to perform frequent manual cleaning or robotic cleaning for the solar module including the inverter with high soiling losses. In another example, the operator needs to perform IV-curve testing on strings connected to an inverter or perform drone-based thermal imaging when the inverter with high systematic loss is detected. Thus, the present invention is of the advantage in that the maintenance ticket is generated only for the particular low-performing inverter and not for the whole system. Thus, corrective steps can be taken by for those inverters which actual need a particular solution on the basis whether the inverter is segregated for soiling loss or systematic loss.

The present disclosure also relates to the method as described above. Various embodiments and variants disclosed above apply mutatis mutandis to the method.

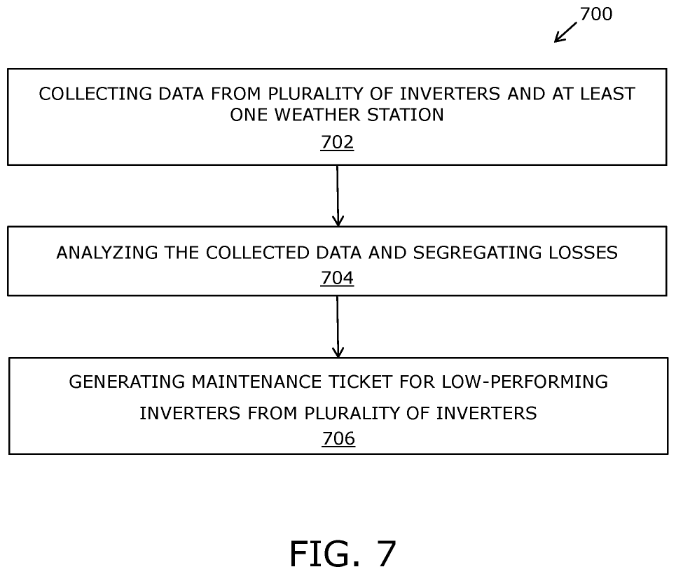

Now referring to FIG. 7, illustrated are steps of a method 700 for monitoring performance of a solar power plant, in accordance with an embodiment of the present disclosure. The method 700 quantifies at least one loss in solar energy generation using data generated from a plurality of inverters in the solar power plant. The method 700 initiates at a step 702, at the step 702 data from the plurality of inverters and at least one weather station is collected using a data collection module (such as the data collection module 102 of FIG. 1). At a step 704 of the method 700 the collected data is analysed and losses are segregated using a data processing arrangement (such as the data processing arrangement 104 of FIG. 1). Specifically, at the step 704, the data processing arrangement 104 implements at least one model to segregate and quantify the losses. At step 706 of the method 700 maintenance ticket for a low-performing inverter from the plurality of inverters is generated using a ticketing module (such as the ticketing module 106 of FIG. 1). At the step 706 the method 700 ends. Particularly, the method 600 compares at least on attribute (typically active power generated) from at least two inverters from the plurality of inverters the data processing module 104 for determining actual power losses.

The steps 702 to 706 of method 700, are only illustrative and other alternatives can also be provided where one or more steps are added, one or more steps are removed, or one or more steps are provided in a different sequence without departing from the scope of the claims herein.

In an embodiment, the losses may include but not limited to a radiation loss, a downtime loss, a soiling loss and a systemic loss.

In another embodiment, the method 700 includes generating a sub-model for the plurality of inverter by measuring the at least one attribute using the data processing module 104.

In another embodiment, the method 700 includes clustering the generated sub-model of the plurality of inverters to remove at least one outliers using the data processing arrangement 104.

In another embodiment, the method 700 includes analysing the clustered sub-model to measure deviation among the at least one attributes for quantifying the soiling losses.

In yet another embodiment, the method 700 includes identifying maxima from the clustered sub-model for the plurality of inverters to quantify systematic losses.

In another embodiment, the at least on attribute includes at least one of an irradiation level, ambient temperature, and module temperature.

Additionally, the above mentioned system and method may be used for performance monitoring of other non-conventional power plants. Such as performance monitoring of a windmill power plants, ocean wave energy harvesting plants and so forth.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural where appropriate.

We claim:

1. A performance monitoring system for a solar power plant, wherein the system, when in operation, quantifies at least one loss in solar energy generation using data generated from a plurality of inverters in the solar power plant, the system comprising:
a data collection module for collecting data from the plurality of inverters and at least one weather station, over a time duration;
a data processing module for analysing the collected data and segregating the losses, wherein the data processing module, when in operation, implements at least one model to segregate and quantify the losses; and
a ticketing module for generating a maintenance ticket for a low-performing inverter from the plurality of inverters,
characterized in that, the data processing module compares at least one attribute of at least two inverters from the plurality of inverters for determining actual power losses.

2. The system as claimed in claim 1, wherein the losses include at least one of a radiation loss, a downtime loss, a soiling loss and a systemic loss.

3. The system as claimed in claim 1, wherein the data processing module, when in operation, generates a sub-model for each of the plurality of inverter by measuring the at least one attribute.

4. The system as claimed in claim 1, wherein the data processing module, when in operation, clusters the generated sub-model of each of the plurality of inverters to remove any present outlier(s).

5. The system as claimed in claim 1, wherein the data processing module, when in operation, analyses the clustered sub-model to measure deviation among the at least one attributes for quantifying the soiling losses.

6. The system as claimed in claim 1, wherein the data processing module, when in operation, identifies maxima from the clustered sub-model for each of the plurality of inverters to quantify systematic losses.

7. The system as claimed in claim 1, wherein the at least on attribute includes at least one of an irradiation level, ambient temperature, and module temperature.

8. A method of (for) monitoring performance of a solar power plant, wherein the method quantifies at least one loss in solar energy generation using data generated from a plurality of inverters in the solar power plant, the method comprising:
collecting data from the plurality of inverters and at least one weather station using a data collection module, over a time duration;
analysing the collected data and segregating the losses using a data processing module, wherein the data processing module implements at least one model to segregate and quantify the losses; and
generating a maintenance ticket for a low-performing inverter from the plurality of inverters using a ticketing module,
characterized in that at least one attribute of at least two inverters from the plurality of inverters are compared using the data processing module for determining actual power losses.

9. The method as claimed in claim 8, wherein the losses include at least one of a radiation loss, a downtime loss, a soiling loss and a systemic loss.

10. The method as claimed in claim 8, wherein the method includes generating a sub-model for the plurality of inverter by measuring the at least one attribute using the data processing module.

11. The method as claimed in claim 8, wherein the method includes clustering the generated sub-model of the plurality of inverters to remove any present outlier(s) using the data processing arrangement.

12. The method as claimed in claim 8, wherein the method includes analysing the clustered sub-model to measure deviation among the at least one attributes for quantifying the soiling losses.

13. The method as claimed in claim 8, wherein the method includes identifying maxima from the clustered sub-model for the plurality of inverters to quantify systematic losses.

14. The method as claimed in claim 8, wherein the at least on attribute includes at least one of an irradiation level, ambient temperature, and module temperature.
